(19) United States
(12) Patent Application Publication
(10) Pub. No.: US 2004/0173105 A1
(43) Pub. Date: Sep. 9, 2004

(54) Multi-purpose blender which can produce vacuum packages

(76) Inventors: Kyung-Soon Kim, Ansan (KR); Joung-Geun Ahn, Ansan (KR)

Correspondence Address: GREENBLUM & BERNSTEIN, P.L.C., 1950 ROLAND CLARKE PLACE, RESTON, VA, 20191, US

(21) Appl. No.: 10/482,409

(22) PCT Filed: Jul. 8, 2002
(86) PCT No.: PCT/KR02/01288

(30) Foreign Application Priority Data
Jul. 10, 2001 (KR) 2001/41204
Sep. 27, 2001 (KR) 2001/60055

(51) Int. Cl. A23B 4/00

(52) U.S. Cl. 99/472

(57) ABSTRACT

The present invention relates to a multi-purposes blender, comprising a main body having a driving motor and a lower coupling rotated by the driving motor; a vacuum generator which is attachable/detachable from the main body, having an upper coupling associated with the lower coupling to rotate, and a vacuum pump driven by the upper coupling; and a vacuum suction device, associated with the vacuum generator, for vacuumizing a vacuum container. According to the present invention, as a vacuum apparatus may be operated by a conventional blender, it has an effect enabling efficient and economic vacuum packaging even at a common home. Also, as rotating speed of the driving motor is set to a slow rotating mode through the vacuum generator of the present invention, and is again decelerated by a gear, there is an effect with vibration and noise of an apparatus decreased.

### TECHNICAL FIELD

The present invention relates to a multi-purpose food blender for vacuum packaging, more particularly to a multi-purpose food blender for vacuum packaging which enables a vacuum packaging so as to facilitate a long-term preservation keeping freshness of food material or nutriment contained in a vacuum container, through leaving intact or remodeling a little the main body of a typical home food blender, and then coupling with a vacuum generator.

Generally, a blender is an apparatus for making juice by chopping up fruits, vegetables, etc. and mixing them with milk, yogurt and so on. Even though the kinds of a food blender are various, a typical blender includes a main body having a driving motor, and a cup having a grinding cutter, equipped at the bottom, for pulverizing fruits, vegetables, etc.

And, a vacuum packaging apparatus is to pack groceries and the likes under a vacuum condition after putting the groceries into a vacuum packing bag or a vacuum container, so that the groceries could be kept for a long time with freshness.

However, as the blender and the vacuum packaging apparatus are separately manufactured and sold with relatively high prices, there is inconvenience for a consumer to purchase, respectively.

### BACKGROUND ART

“A food blender with a vacuum packaging apparatus” was registered originally in Korean Intellectual Property Office for utility model, No. 231617 (Registered Date: May 10, 2001) by Ahn Jung-geun, who is same as the inventor of this patent application.

As illustrated in FIG. 1, the conventional blender includes a container 10 for containing groceries, a grinding part 20 with a grinding cutter, a main body 70 including a driving motor and a vacuum pump, a vacuum container suction device 100 for sucking the internal air of a vacuum container, and a vacuum packaging device 90 for sucking the internal air of a vacuum packing paper as well as for sealing a vacuum packing bag, thereby enabling not only the blender but also the vacuum packaging by using one apparatus.

However, if the vacuum pump were installed in the main body of the typical blender, there might be some problems with the main body of the blender getting unnecessarily bigger, as well as not compatible with a common home blender. Also, even though a grinding cutter 12 of the blender is rotated with fast speed and a vacuum pump is rotated with slow speed, the speed of the driving motor is not effectively decelerated, thereby, leaving a problem of generating severe vibration and noise, as well as of energy losses, when the vacuum pump is worked.

### DISCLOSURE OF INVENTION

The object of present invention devised for solving problems of the aforementioned conventional art is to provide a multi-purpose blender available for grinding efficiently fruits, vegetables, etc. and for vacuum packaging.

It is, also, another object of the present invention to provide a multi-purpose blender for vacuum packaging using a typical home food blender.

It is another object of the present invention to provide a multi-purpose blender for vacuum packaging, which can adjust the rotating speed of a driving motor according to a required speed of a grinding cutter rotating with fast speed as well as a vacuum pump rotating with slow speed.

It is further object of the present invention to provide a multi-purpose blender for a vacuum packaging, which can stop a vacuum generator by controlling mechanically a driving motor when the vacuum pressure inside the container reaches the preset certain degree.

It is still object of the present invention to provide a multi-purpose blender for a vacuum packaging equipped with a vacuum display device to easily check vacuum pressure

To achieve the objects, there is provided a multi-purpose blender for a vacuum packaging, includes: a main body having a driving motor and a lower coupling rotated by the driving motor, a vacuum generator which is attachable/detachable from the main body, having an upper coupling associated with the lower coupling to rotate, and a vacuum pump driven by the upper coupling; and an vacuum suction device, associated with the vacuum generator, for vacuumizing a vacuum container.

Also, the speed of the driving motor of the multi-purpose blender for a vacuum packaging of the present invention can be decelerated mechanically and transferred to the vacuum pump with appropriate speed to operate. Also, the speed of the vacuum pump can be electrically decelerated with the driving motor to be controlled manually in a fast mode or in a slow mode.

Also, a vacuum display device of the present invention is equipped on the vacuum generator or the vacuum suction device, thereby displaying the process of the vacuum state.

Also, the vacuum generator can be automatically stopped after reaching a predetermined vacuum pressure in the vacuum container, since a pressure sensor is equipped and mechanically operated.

### BRIEF DESCRIPTION OF DRAWINGS

The objects, features and advantages of the present invention will become more apparent from the following detailed description when taken in conjunction with the accompanying drawings, in which:

FIG. 1 is a perspective drawing of a conventional multi-purpose blender for vacuum packaging.

FIG. 2 is an exploded drawing of a multi-purpose blender according to the first embodiment of the present invention.

FIG. 3 is an approximate longitudinal sectional drawing according to the first embodiment of the present invention.

FIG. 4 is a whole perspective drawing of a multi-purpose blender according to the second embodiment of the present invention.

FIG. 5 is a sectional drawing for a main body of a blender according to the second embodiment of the present invention.

FIG. 6 is a sectional drawing with a vacuum generator being coupled with a main body of a blender according to the second embodiment of the present invention.

FIG. 7 is a sectional drawing of a vacuum suction device according to the second embodiment of the present invention.

FIG. 8 is a sectional drawing with a cup being coupled with a main body of a blender according to the second embodiment of the present invention.

FIG. 9 is a circuit diagram illustrating mutual relation of power switch, pressure switch, vacuum switch and blender switch according to the second embodiment of the present invention.

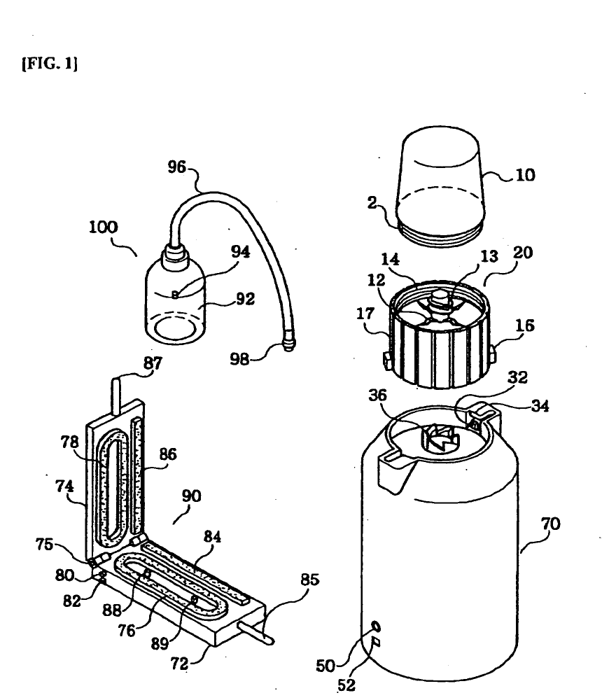

### BEST MODE FOR CARRYING OUT THE INVENTION

A preferred embodiment of the present invention will now be described with reference to the accompanying drawings.

Embodiment 1

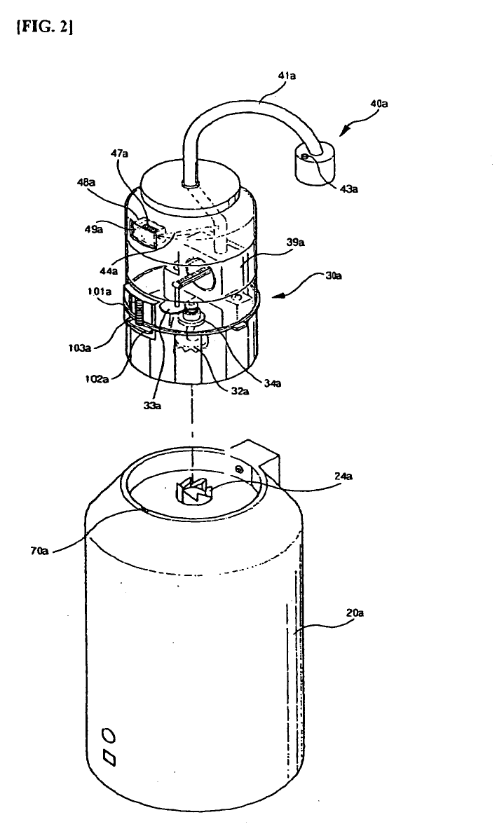

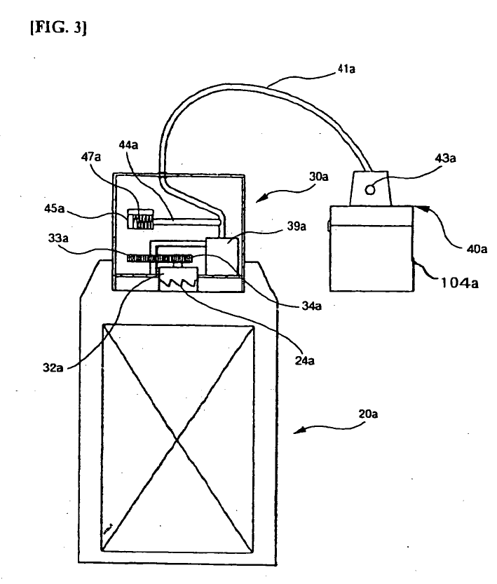

Now, the first embodiment of the present invention will now be described with reference to FIGS. 2 and 3.

As illustrated in FIGS. 2 and 3, a multipurpose blender includes a main body 20a where a driving shaft being rotated by a driving motor (not illustrated in Figure) is internally installed and a driving shaft is coupled with an upper end of a lower coupling 24a, a vacuum generator 30a, and a vacuum suction device 40a.

The main body 20a of the blender can utilize the main body of the conventional blender, which has a switch at the upper part as it is.

Two gears 33a and 34a are installed between an upper coupling 32a and a vacuum pump 39a in the vacuum generator 30a, thereby decelerating and operating the vacuum pump 39a.

And, as a piston 48a is installed by a spring 47a in the vacuum generator 30a, the progress state of the vacuum packaging is displayed. As, at this time, a transparent window 49a is formed in an end of one side of the vacuum generator 30a, the motion of the piston 48a is displayed to the outside.

A tension plate 102a is moved tip and down by installing a guide 101a, at a constant height, on the outer surface of the vacuum generator 30a, and by installing a tension plate 102a on the guide 101a by spring 103a.

The gears 33a and 34a includes a small diameter gear 34a being coupled with an upper coupling 32a at the same shaft, and a big diameter gear 33a, being rotated at the position separated from a constant distance from a central axis of the small diameter gear 34a, being coupled with vacuum pump 39a.

As illustrated in FIG. 2, a suction port of the vacuum pump 39a is linked to a vacuum display device including a piston 48a through a passage 44a, and also linked to a vacuum suction device 40a with a pressure releasing switch at an end part.

As illustrated in FIG. 3, when the main body 20a and the vacuum generator 30a are coupled each other, the lower coupling 24a and the upper coupling 32a are coupled each other to be rotated.

Also, at this time, the tension plate 102a installed by the spring 103a at the guide 101a presses a switch 70a, thereby operating the driving motor.

An unexplained numeral 104a is a vacuum container in FIG. 3.

The operation of the blender of the present invention will be described in detail.

As illustrated in FIGS. 2 and 3, the main body 20a and the vacuum generator 30a are coupled, and the vacuum suction device 40a is linked to the vacuum container 104a for containing food. So, the vacuum pump 39a can be operated by the lower coupling 24a of the main body 20a rotated by a driving motor passing through the upper coupling 32a and gears 34a and 33a.

That is, as the tension plate 102a supported by the spring 103a presses the switch 70a of the main body 20a, a power source is supplied to rotate the driving motor, thereby operating the vacuum pump 39a.

Through the passage 44a, the vacuum state is transferred to the piston 45a of the vacuum display device. So, the spring 47a is compressed by pressure varied due to the vacuum condition, and the piston 45a is moved. The motion of the piston 45a is shown to the outside by the transparent window 49a, thereby checking a proceeding state of the vacuum packaging.

On the other hand, the inside air of the vacuum container 104a is flowed into the vacuum pump 39a through the tube 41a, and the vacuum condition is slowly progressed.

As doing like this, after the vacuum state is completed in a certain time, the vacuum generator 30a is lifted upward from the main body 20a, the switch 70a is opened, thereby stopping a driving motor and the vacuum pump 39a.

At this state, since the pressure releasing switch 43a of the vacuum suction device is pressed, the vacuum state of the tube 41a is released, in addition, the vacuum suction device 40a is separated from the vacuum container 104a. Accordingly, the vacuum packaging of the vacuum container 60 for containing food is completed.

As the vacuum state is released, the piston 45a of the vacuum display device 45a is returned to an original position by the spring 47a.

On the other hand, the motor speed is decelerated by the gears 33a and 34a installed in the vacuum generator 30a. Also, as the tension plate 102a is supported by the spring 103a, the main body 20a of the blender has different size each depending on a manufacturer. However, when the vacuum generator 30a is inserted, the switch 70a is always operated in normal, regardless of the depth of the blender main body 20a.

Embodiment 2

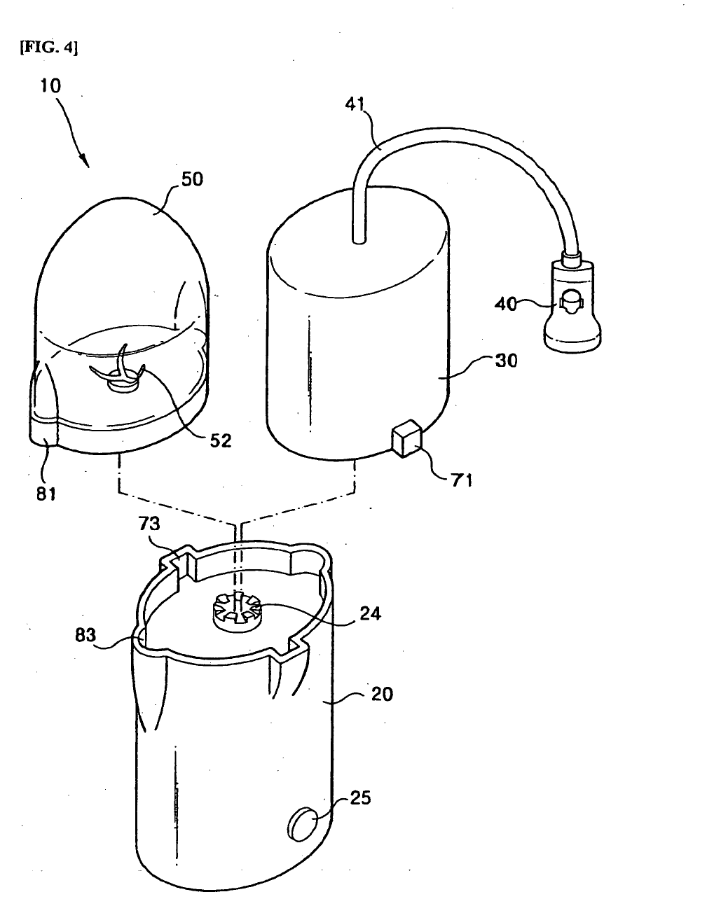

Hereinafter, the second embodiment of the present invention will now be described with reference to FIGS. 4 through 9.

FIG. 4 is a whole perspective drawing of multi-purpose blender for vacuum packaging. The multi-purpose blender 10 broadly includes a main body 20, a vacuum generator 30, a vacuum suction device 40 and a cup 50. In case the vacuum generator 30 is assembled into the main body 20, the vacuum generator 30 forms the vacuum state, and, the vacuum container is vacuum-packed through the vacuum suction device 40 coupled with vacuum generator 30. Also, in case a cup 50 is assembled into the main body 20 of a blender, the fruits and the likes can be pulverized, thereby making juice by the grinding cutter 52.

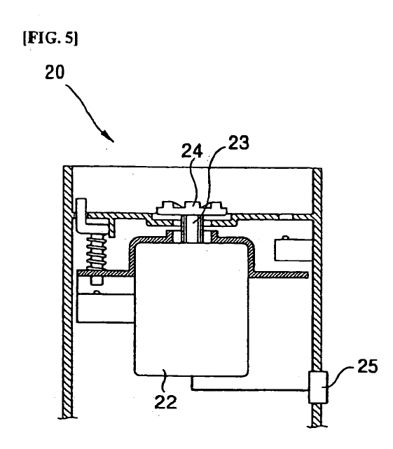

FIG. 5 is a sectional drawing of the main body of multi-purpose blender 10 illustrated in FIG. 3. The main body 20 is similar to that of a typical blender which is used in general, including a driving motor 22, a driving shaft 23 for transferring rotary force of the driving motor 22, and a lower coupling 24 placed at an upper part of the driving shaft 23. The driving motor 22 rotates the driving shaft 23 through an external power source or its battery. As the power switch 25 is installed to one lower part of the main body 20, the power supply of the driving motor 22 is controlled. As the lower coupling 24 is coupled with an upper coupling 32 of the vacuum generator 30 or a cup 50, the rotary power is transferred to the outside.

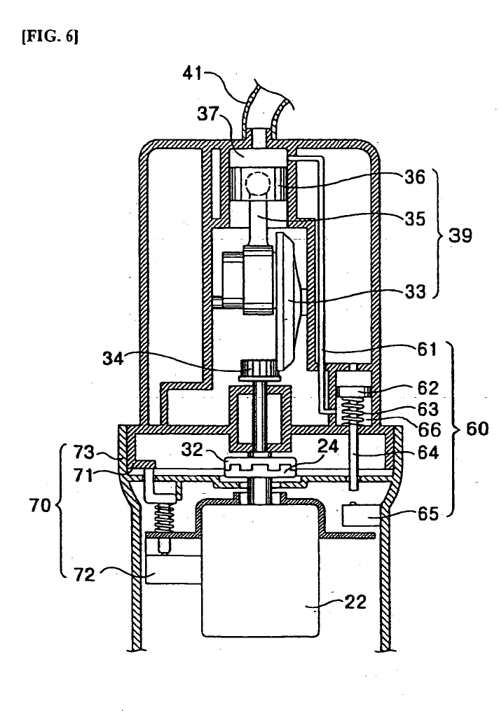

FIG. 6 is a sectional drawing with the vacuum generator 30 used for multi-purpose blender 10 illustrated in FIG. 4, coupled with the main body 20. As a joint projection 71 of the vacuum generator 30 is projected at the lower part of the vacuum generator 30 in the shape of a quadrilateral, it is assembled, being inserted into joint glove of a quadrilateral formed in the main body 20. As, at this time, the lower coupling 24 and the upper coupling 32 are in gear, the rotary force of the driving motor 22 is transferred to the vacuum pump 39. Also, as, at this time, the lower part of the joint projection 71 reaches a limit switch 72 placed in the main body 20, the limit switch 72 is closed, leading to the driving motor 22 being rotated in a slow mode. Also, as, at this time, the lower part of the rod 64 at the vacuum generator is positioned above the upper part of a switch 65 positioned in the main body 20, in case the rod 64 is descended, the switch 65 is reached, leading to the switch 65 being opened.

The vacuum generator 30 includes broadly an upper coupling 32, Bevel gears 33 and 34, a vacuum pump 39 which is preferably a piston pump. As the upper coupling 32 is coupled with the lower coupling 24 of the main body, the upper coupling 32 is rotated 20 through the rotation of the lower coupling 24. The small diameter gear 34 of Bevel gears is installed at the same shaft as the upper coupling 32. As the big diameter 35 and the small diameter gear 34 of Bevel gears are engaged, the rotating speed of the driving motor 22 is decelerated. As an upper part of the rod 35 of piston pump 39 is connected to a eccentric side of the big diameter gear 35, according to the rotation of the big diameter gear 35 the piston 36 makes reciprocation movement. Accordingly, air is sucked from the suction port 37, and air is discharged through an exit (not illustrated).

Describing the pressure switch unit 60, a cylinder 66 having a piston 62, a rod 64 and a return spring 63, is installed in an inside of the vacuum generator 30, and a switch 65 is installed in the main body 20 so as to be contacted in case the rod 64 is descended, and the switch 65 is closed in a normal state. At a part of the cylinder 66 installed with the return spring 63, a connecting tube 61 is linked to the suction port 37 of the piston pump, and the opposite part of the cylinder 66 is opened to the air. As the vacuum state is formed in the suction port 37, in case of reaching a constant vacuum pressure, the rod 64 is descended depending on the difference between atmospheric pressure and vacuum pressure. As, after an amount is descended, the rod 64 reaches the switch 65, the power source of the driving motor 22 is cut-off When the vacuum state at the suction port 37 is released, the rod 64 is returned to original position through the return spring 63.

Describing the vacuum switch unit 70, the vacuum switch unit 70 includes a joint projection 71 for vacuum packaging, a joint groove 73 and a limit switch 72. The joint projection 71 is projected in quadrilateral shape at the lower part of a housing of the vacuum generator 30 to be formed, and a joint groove 73 is positioned at the upper part of the main body 20 to be coupled with the joint projection 71. In case the joint projection 71 and joint groove 73 are coupled, the lower part of the joint projection 71 reaches the limit switch 72 equipped in the main body 20, leading to the limit switch 72 closed, and to the driving motor 22 being rotated in a slow mode. As, in some cases, the side part of the joint projection 71 reaches the limit switch 72 formed in the main body 20, leading to the limit switch 72 being closed and rotated in a slow mode.

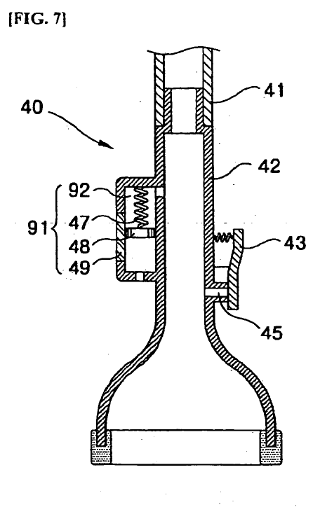

FIG. 7 is a sectional drawing of the enlarged the vacuum suction device-40 used in multi-purpose blender illustrated in FIG. 4. The vacuum suction device 40 includes a tube 41, a suction means 42, a pressure-releasing switch 43 and a vacuum display device 91. The tube 41 is coupled with a suction port 37 of the vacuum generator, and the suction means 42 is positioned between the tube 41 and the vacuum container to suck the vacuum container. The pressure-releasing switch 43 is located on one side edge of the suction means 42 by opening a hole 45, The pressure releasing switch 43 connects atmosphere to the inside of and the suction means 42, and releases the vacuum formed in the inside of the suction means 42 in case of the vacuum packaging. The vacuum display device 91 is equipped on the other side edge of the suction means 42, and has a shape of the cylinder 92 with a piston 48, a return spring 47 and a transparent window 49. As one side of the cylinder 92 is coupled with the atmosphere, and the opposite side of the cylinder 92 is coupled with the inside of the suction means 42 depending on the difference between the internal vacuum pressure and atmospheric pressure of the suction means 42, the piston 48 is moved. The motion of the piston 48 is displayed on the outside through the transparent window 49, and a user can check a state of the vacuum pressure of the internal suction means 42. After the vacuum pressure is released, the piston 48 is returned to original position through the return spring 47. The vacuum suction device can be coupled to a separate vacuum source, and may make the vacuum state in the inside of vacuum container.

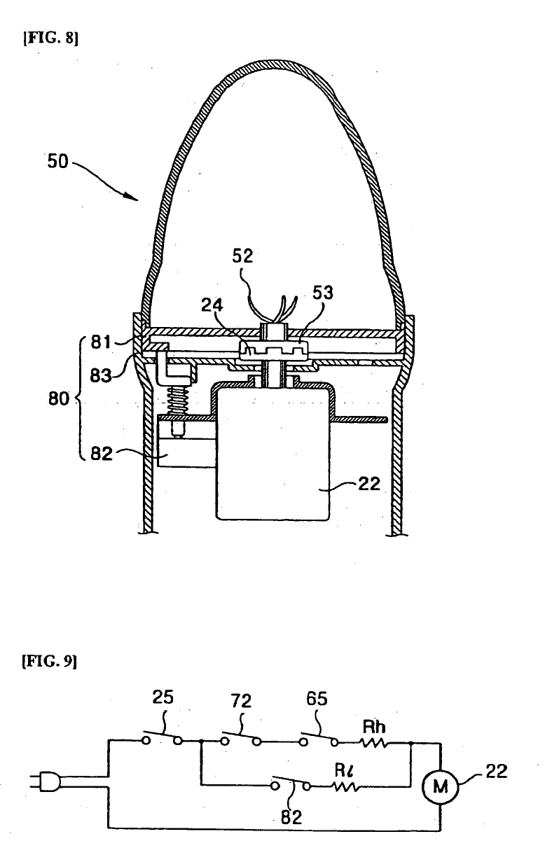

FIG. 8 is a sectional drawing with a cup for the multi-purpose blender 10 illustrated in FIG. 4, coupled to the main body 20. The cup for the blender 50 has a cup type, and the grinding cutter 52 and the upper coupling 53 are equipped on a lower part of the cup. As the joint projection 81 of the cup is projected at the lower part of the cup for the blender 50 in the shape of semicircle, it is inserted into the joint groove 83 equipped in the upper part of the blender main body 20 to be assembled. As, at this time, the lower coupling 24 and the upper coupling 53 are engaged, the rotary force of the driving motor 22 is transferred to the grinding cutter 52. Also, at this time, as the lower part of the joint projection 81 reaches the limit switch 82 equipped in the main body 20, the limit switch 82 is closed and the driving motor 22 is rotated in the fast mode. As, in some cases, the side part of the joint projection 81 reaches the limit switch 82 equipped in the main body 20, the limit switch 82 is closed, thereby enabling the driving motor 22 being rotated in the fast mode.

The blender switch unit 80 includes the joint projection 81, a joint groove 83 and the limit switch 82. As the joint projection 81 and the joint groove 83 become other shape respectively as to the joint projection 71 and the joint groove 73 for the vacuum state, the joint projection 81 is sure to be coupled with the joint groove 83, leading to the limit switch 82 closed, and to-no wrong operation.

FIG. 9 is a circuit drawing illustrating roughly the mutual relation among a power switch 25, a pressure switch 65, a limit switch 72. The power switch 25 intercepts the main power of the driving motor 22. The pressure switch 65 and the limit switch 72 are coupled, and the pressure switch 65 is closed in a normal state, and the limit switch 72 is opened in a normal state. Accordingly, when the vacuum generator 30 and the main body 20 are coupled, the limit switch 72 is closed and the driving motor 22 is coupled to high resistance (Rh), leading to the driving motor 22 being rotated in the slow mode. In case of reaching a constant vacuum pressure necessary for vacuum packaging, the pressure switch 65 is opened, leading to the power source of the driving motor 22 intercepted. In the slow mode, the limit switch 82 is always in an open state.

The limit switch 82 is closed when the cup 50 and the main body 20 are coupled, and is opened in a normal state. In case the limit switch 82 is closed, the driving motor 22 is coupled with low resistance (Rl), leading to the driving motor 22 rotated in the fast mode. In the fast mode, the limit switch 72 is always in an open state. Also, the fast mode and the slow mode of the driving motor 22 may be available through speed control circuit of generally various motors.

Availability for Industry

As described above, as the vacuum apparatus may be operated by a typical blender, using a multi-purpose blender according to the present invention, it has effect enabling efficient and economic vacuum packaging even at a common home.

Also, as the rotating speed of driving motor is set to the slow rotating mode through the vacuum generator of the present invention, and is again decelerated by a gear, there is an effect with vibration and noise of an apparatus decreased.

Also, there is an effect with reliability of operation being improved, as, due to mechanical pressure switch unit, the manufacture cost is lower than that of power control of the driving motor through conventional pressure sensor, as simple modification is available, and as there is no danger of wrong operation and electric shock which may be caused by liquid of juice flowing into control device of the pressure sensor.

Also, through the vacuum display device equipped in the vacuum suction device or vacuum generator of the present invention, there is an effect confirming easily vacuum pressure of the vacuum container.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A multi-purpose blender for vacuum packages, comprising:
a main body having a driving motor and a lower coupling rotated by the driving motor;
a vacuum generator which is attachable/detachable from the main body, having an upper coupling associated with the lower coupling to rotate, and a vacuum pump driven by the upper coupling; and
a vacuum suction device, associated with the vacuum generator, for vacuumizing a vacuum container.

2. The multi-purpose blender for vacuum packages according to claim 1, wherein the rotating speed of the driving motor can be decelerated by assembling the upper coupling and a vacuum pump by gears.

3. The multi-purpose blender for vacuum packages according to claim 1, further comprising:
a guide equipped on the outer surface of the vacuum generator with a constant height; and
a tension plate, equipped on the guide by a spring, for closing a switch equipped on an upper part of the main body.

4. The multi-purpose blender for vacuum packages according to a claim 1, 2 or 3, further comprising:
a vacuum display device which includes a piston moved by the difference between an atmospheric pressure and a vacuum pressure, a transparent window through which the piston motion is displayed to an outside; and a spring for returning the piston to an original position,
wherein the vacuum display device is equipped on an outer surface of the vacuum generator.

5. The multi-purpose blender for vacuum packages according to claim 1, further comprising a vacuum switch unit having a vacuum limit switch located in a quadrilateral joint groove formed in an upper part of the main body,
wherein the driving motor is rotated in a slow mode by closing the vacuum limit switch by the quadrilateral joint projection formed in the lower part of the vacuum generator.

6. The multi-purpose blender for vacuum packages according to claim 5, further comprising a blender switch unit having a blender limit switch located in a semi circular joint groove formed in an upper part of the main body,
wherein the driving motor is rotated in the fast mode by closing the blender limit switch by the semi circular joint projection formed in the lower part of a blender cup.

7. The multi-purpose blender for vacuum packages according to claim 5 or 6, wherein the rotating speed of the driving motor can be decelerated by assembling the upper coupling and a vacuum pump by a Bevel gear.

8. The multi-purpose blender for vacuum packages according to a claim 1, 2, 5 or 6, further comprising:
a vacuum display device which includes a piston moved by the difference between an atmospheric pressure and a vacuum pressure, a transparent window through which the piston motion is displayed to an outside; and a spring for returning the piston to an original position,
wherein the vacuum display device is equipped on an outer surface of the vacuum suction device.

9. The multi-purpose blender for vacuum packages according to a claim 1, 2, 5 or 6, further comprises a pressure switch unit installed in the main body and closed in a normal state, and a rod installed both in the vacuum generator and arranged above the pressure switch unit,
wherein in case of a vacuum state, the rod is descended by a difference between a vacuum pressure and an atmospheric pressure, thereby opening the pressure switch unit and cutting off the power source of the driving motor.

10. The multi-purpose blender for vacuum packages according to a claim 1, 2, 5 or 6, wherein the vacuum generator comprises:
an upper coupling coupled with a lower coupling of the main body to rotate; a small diameter gear of the Bevel gear connected to the upper coupling; a big diameter gear of the Bevel gear assembled with a piston rod of the vacuum pump in eccentric position; a vacuum pump being a type of a piston pump;
a cylinder equipped in the vacuum generator, a hole opening one part of the cylinder to the atmosphere; a connecting tube linking the opposite side of the cylinder to a suction port of the vacuum generator; a rod descended by a difference between the vacuum pressure of the suction port and the atmospheric pressure of the suction port.

11. The multi-purpose blender for vacuum packages according to a claim 1, 2, 5 or 6, wherein the vacuum suction device includes a tube for connecting the vacuum generator and the vacuum container each other; a suction means coupled with the tube; a vacuum releasing switch for opening and closing a hole formed in the suction means; a piston moved by a difference between the atmospheric pressure and the vacuum pressure of the internal suction means; a transparent window for displaying the motion of the piston to an outside; and a spring for returning the piston to an original position.

12. A vacuum generator for a blender, comprising:
an upper coupling coupled with a lower coupling of the blender's main body to rotate; a small diameter gear of the Bevel gear connecting to the upper coupling; a big diameter gear of the Bevel gear assembled with a piston rod of the vacuum pump in eccentric position; a vacuum pump being a type of a piston pump;
a cylinder equipped in the vacuum generator; a hole opening one part of the cylinder to the atmosphere; a connecting tube linking the opposite side of the cylinder to a suction port of the vacuum generator; a rod descended by a difference between the vacuum pressure of the suction port and the atmospheric pressure.

13. A vacuum suction device, comprising:
a tube for connecting a vacuum source and the vacuum container each other,
a suction means coupled with the tube;
a vacuum releasing switch for opening and closing a hole formed in the suction means;
a piston moved by a difference between the atmospheric pressure and the vacuum pressure of the internal suction means;
a transparent window for displaying the motion of the piston to an outside; and
a spring for returning the piston to an original position.
